(19) United States
(12) Patent Application Publication
(10) Pub. No.: US 2004/0024655 A1
(43) Pub. Date: Feb. 5, 2004

(54) Direct response e-mail

(75) Inventor: Anthony D. Estes, Arlington, MA (US)

Correspondence Address: FISH & RICHARDSON PC, 225 FRANKLIN ST, BOSTON, MA, 02110, US

(73) Assignee: E-Dialog, Inc.

(21) Appl. No.: 10/409,712

(22) Filed: Apr. 4, 2003

Related U.S. Application Data
(63) Continuation of application No. 09/353,896, filed on Jul. 16, 1999.

(51) Int. Cl. G06F 17/60

(52) U.S. Cl. 705/26

(57) ABSTRACT

An e-mail message is analyzed to derive response information concerning a commercial transaction. Based on the derived information, commercial transaction data are automatically generated in a format that is usable to automatically complete the commercial transaction.

### FIELD OF INVENTION

This invention relates to direct response e-mail.

### BACKGROUND OF THE INVENTION

In direct response e-mail, a vendor, for example, can sell a product to a customer by sending an e-mail message to the customer that describes the product and its price. The customer can order the product by returning an e-mail (sometimes called a direct response e-mail) that gives appropriate order information. The vendor can confirm the order by a return e-mail. The order information returned by the customer can sometimes be determined automatically using software that analyses the customer's reply e-mail.

### SUMMARY OF THE INVENTION

In general, in one aspect of the invention, an e-mail message is analyzed to derive response information concerning a commercial transaction. Based on the derived information, commercial transaction data are automatically generated in a format that is usable to automatically complete the commercial transaction.

In general, in another aspect of the invention, an e-mail message is sent to a customer offering a product or service for sale. The e-mail message includes locations for response by the customer to indicate his intention to order the product or service. The customer returns an e-mail message that includes the response. Based on the received e-mail, order information is automatically generated in a format usable automatically by an order fulfillment system to cause the order to be filled.

In general, another aspect of the invention includes automatically identifying response information which requires resolution of an issue with the source of the e-mail message and automatically managing an e-mail dialog with the source to resolve the issue.

In general, in another aspect, the invention features automatically sorting e-mail messages, based on response information contained in the messages, into e-mail messages that can be processed automatically to generate commercial transactions, e-mail messages in which the response information is inadequate to permit generation of commercial transactions, and e-mail messages that may be subjected to exception handling to yield information that is sufficient to generate commercial transactions.

In general, in another aspect, the invention features automatically generating a confirmatory e-mail message to the source of the e-mail message confirming that a commercial transaction has been or will be completed.

In general, in another aspect, the invention features receiving inbound e-mail messages that result from corresponding outbound e-mail messages associated with a marketing program, the inbound messages containing response information, each of the outbound messages being associated with a distinct piece of the marketing program. The response information in each of the inbound messages is automatically associated with the corresponding distinct piece of the marketing program.

In general, in another aspect, the invention features automatically merging response information with corresponding information in a database for use in completing transactions.

In general, in another aspect, the invention features identifying inbound e-mail messages that cannot be processed automatically to generate commercial transactions, and using the database information to assist in exception handling of the identified inbound messages.

Other advantages and features will become apparent from the following description and from the claims.

### BRIEF DESCRIPTION OF THE DRAWING

FIGS. 1A through 1C and 2A through 2B show e-mail messages.

FIG. 3 is a block diagram of a direct response e-mail system.

### DESCRIPTION OF THE PREFERRED EMBODIMENTS

Outbound E-Mail Messages

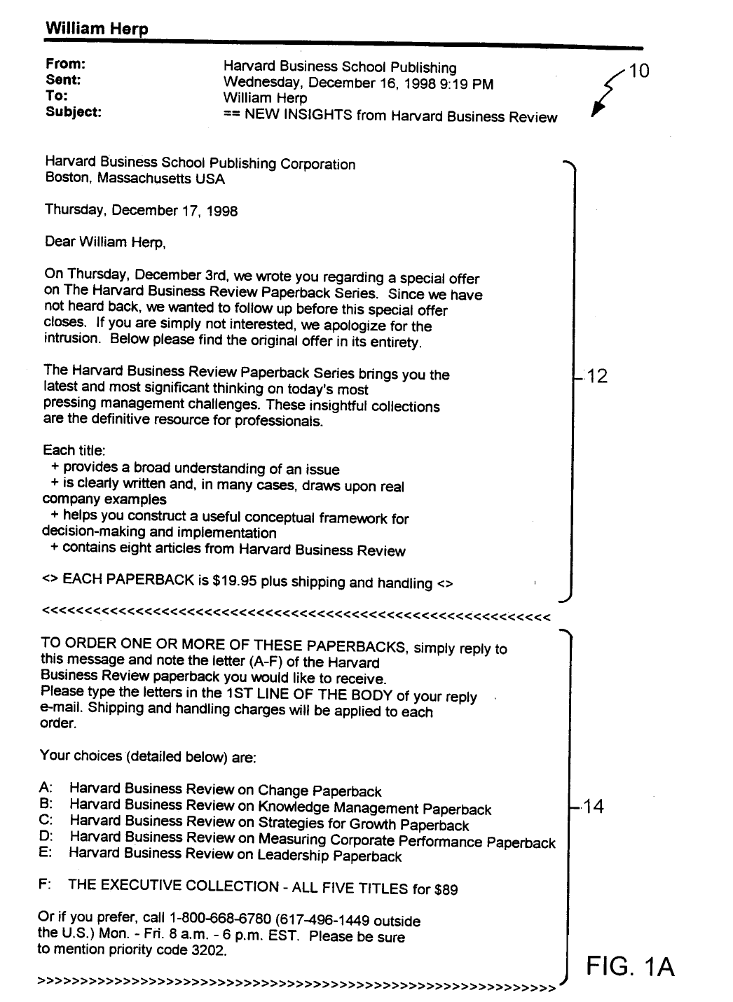

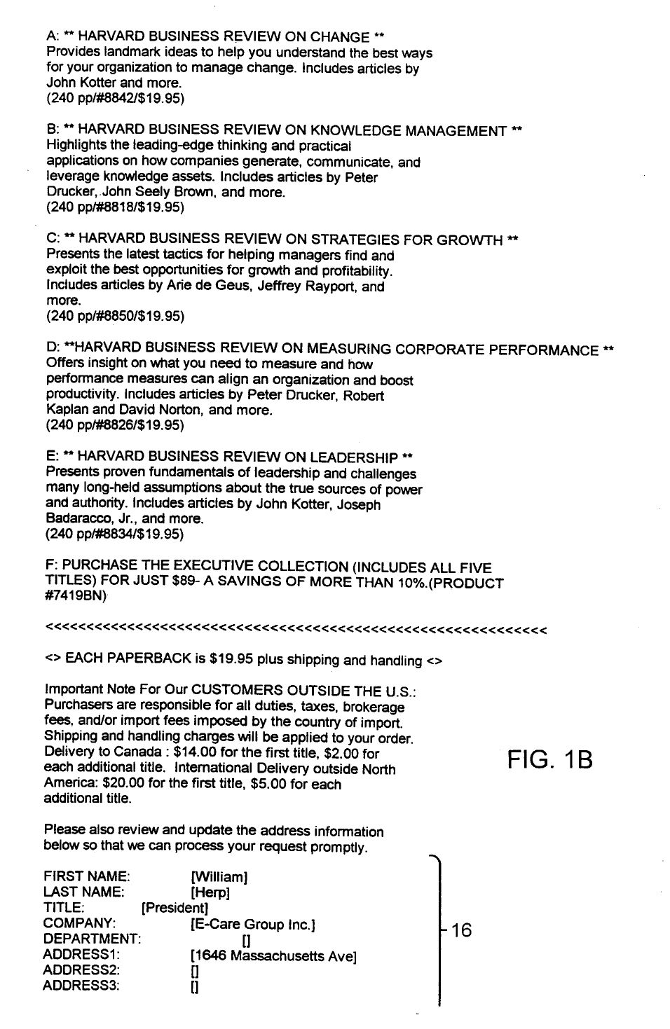

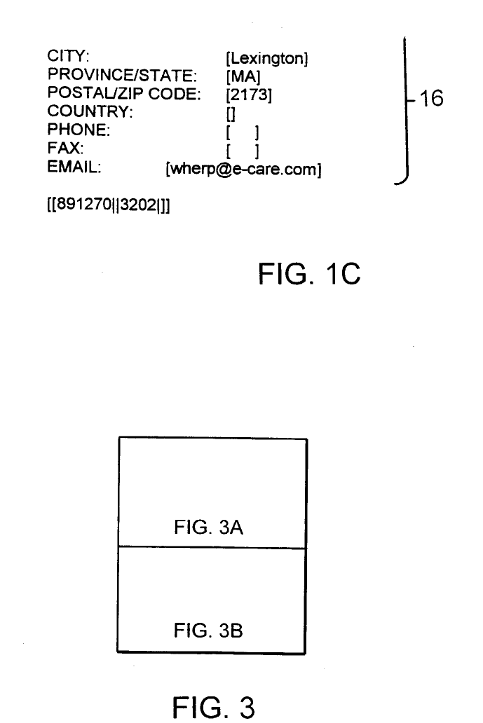

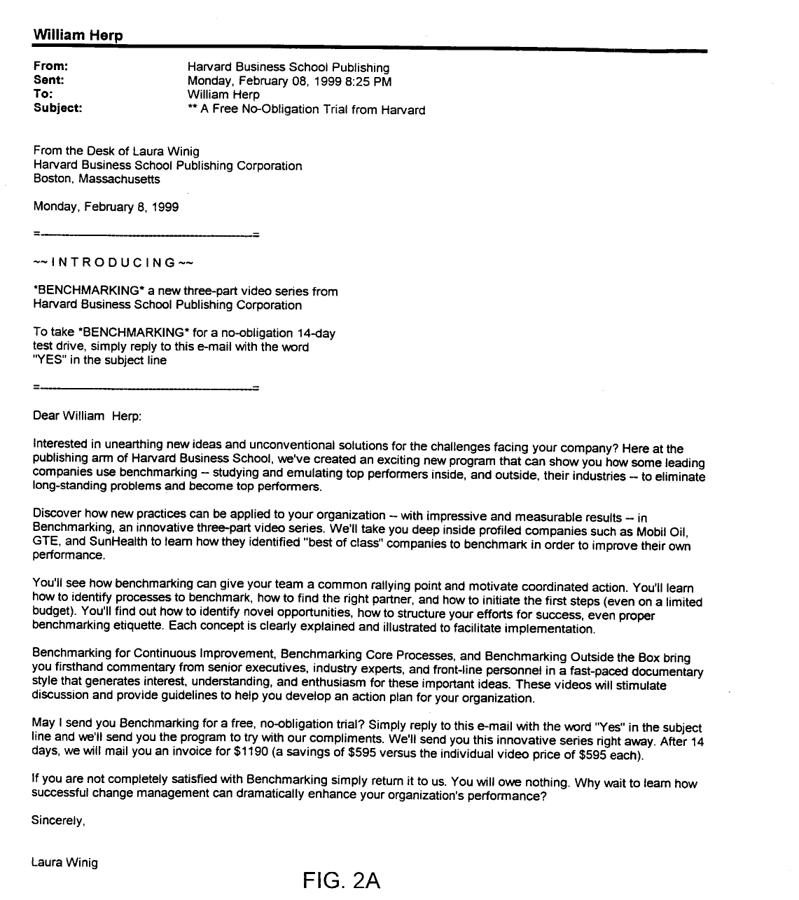

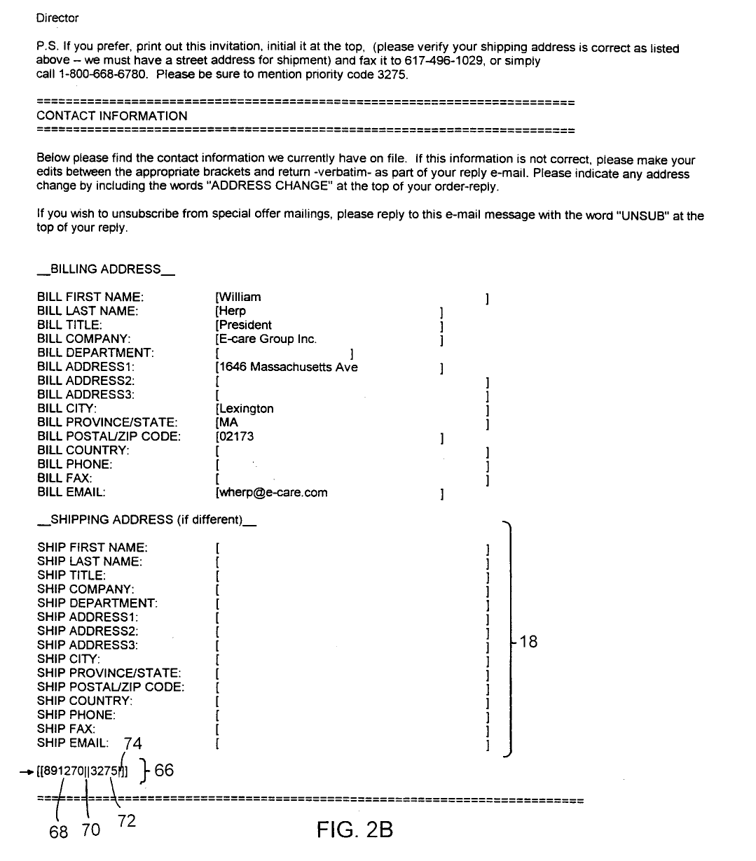

The two e-mail messages shown in FIGS. 1A through 1C and 2A through 2B are examples of outbound messages associated with commercial transactions.

The example message 10 shown in FIG. 1 offers Harvard Business Review products. Message 10 includes basic copy 12 that is similar to basic direct marketing copy of the kind that is commonly used in e-mail marketing. Message 10 also contains a section 14 giving instructions on how to order the products.

Inbound E-Mail Messages

To take advantage of the-offer shown in FIG. 1, the recipient creates a reply e-mail message (the direct response message) and types the letters of the items that he wants to order in the first line of the body of the message. In other examples, the letters could be typed in the subject line or the last line of the body of the message. The user is also asked to correct and complete shipping and e-mail address information that has been merged into the outbound e-mail message in a section 16. In section 16, each of the entries is bounded by brackets. Another section could contain merged billing information, not shown. The person who replies to the e-mail (the customer) is meant to include the corrections or additions within the indicated brackets.

By allowing the recipient to take advantage of the offer simply by replying to the e-mail, rather than requiring the recipient to place an order by linking to a related web-site or to print the e-mail message and FAX it back, or to call an 800 number, a much higher return rate can be achieved. For conventional outbound e-mail messages that require the recipient to click on an embedded URL to go to a web site, the returns may be on the order of several hundred percent on investment (the fee charged for delivering the outbound messages). By enabling the recipient to provide direct response e-mail messages as in FIG. 1, the return on investment can be as high as several thousand percent.

FIGS. 2A and 2B illustrate a similar outbound e-mail message in which there is no choice of products but only a single offer to be accepted or rejected. To take advantage of the offer, the recipient types “yes” in the subject line. In FIG. 2B, a shipping block 18 of the kind mentioned above is shown. (In this case, the shipping block contains no information because the shipping address is the same as the billing address.)

One reason for including differential billing and shipping blocks is to acquire information in the return e-mail message that is similar to information captured in orders placed on a related web site. In a system in which web-site orders generate fields that can be fed directly to an automated order fulfillment process, it is useful to make the e-mail message information field-wise consistent to permit the information to be delivered automatically to the same order fulfillment process.

Exception Processing

Processing the inbound e-mails (the ones with responses concerning commercial transactions from the recipients of the outbound e-mails) may require custom interaction with the recipients. For example, the wording of the outbound messages may be confusing to the recipients.

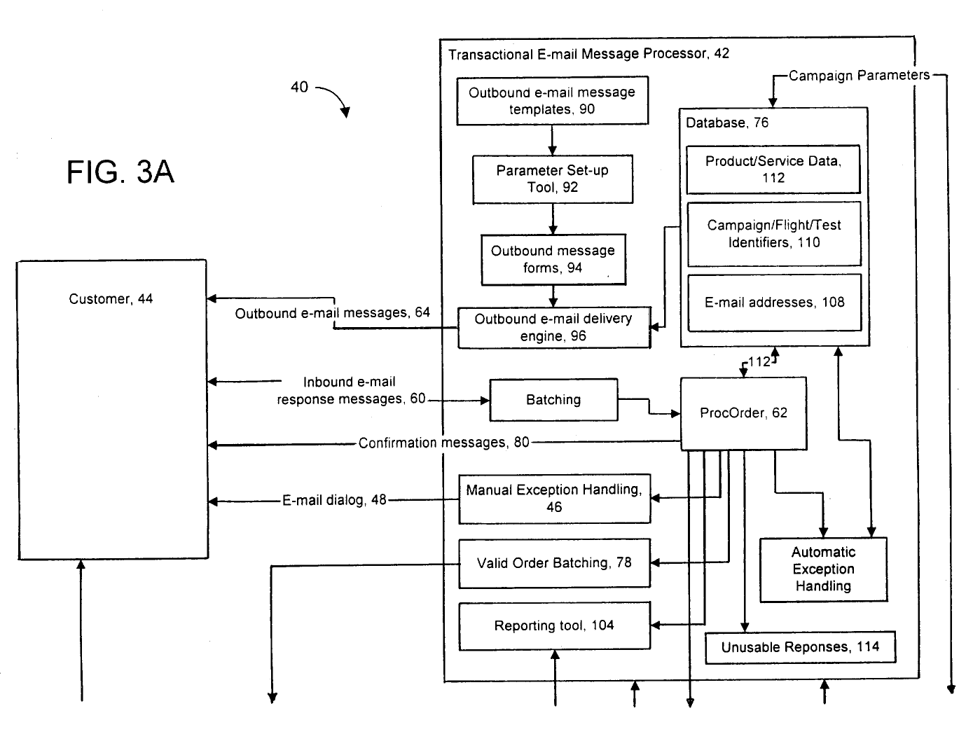

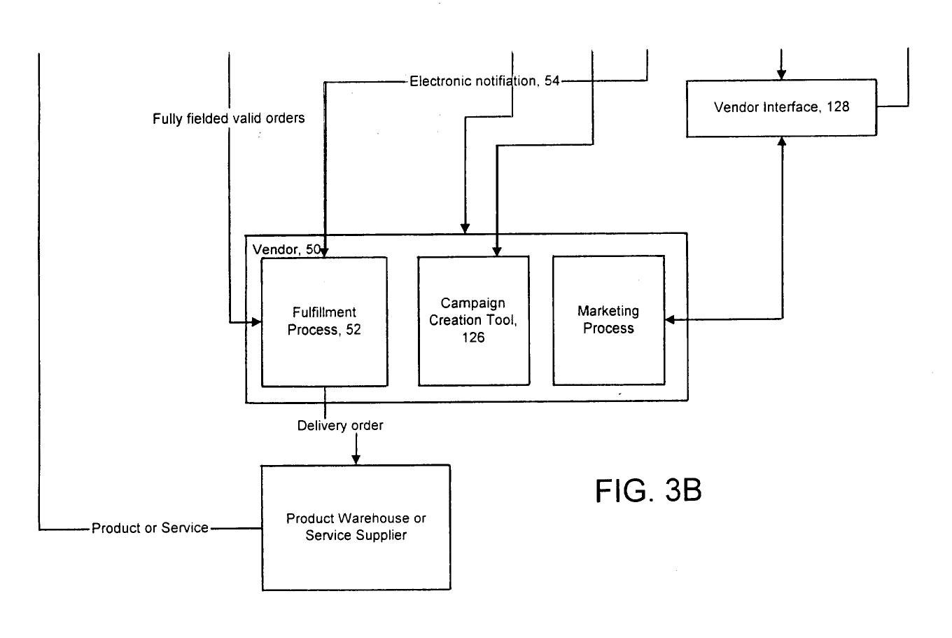

As shown in FIG. 3, the system 40 enables the transactional e-mail message processor 42 to determine when a dialog with the recipient 44 is needed and then assists a human service representative 46 to conduct an effective dialog 48. The dialog can be conducted on behalf of the vendor 50 but without involving the vendor. Alternatively, the vendor's fulfillment process 52 can be notified electronically 54 of interaction that may be required. Easing the processing of responses that include customer orders is important because the orders-typically come back quickly, e.g., within 36-48 hours, and in large volume. The ability to deal with questions that arise as a result of the contact from a customer service point of view keeps the vendor's customer service organization from being overwhelmed by the responses that come back.

The ability to process exceptions without involving the customer service organization of the vendor is based partly on knowing how the outbound e-mail messages were constructed. As a simple example, a recipient may ask an unnecessary question that could have been answered by reading the outbound e-mail message. The e-mail message processor can pull out the relevant portion of the message and send it back to the recipient to answer the question.

ProcOrder Process

The inbound e-mail messages 60 are batch processed by a script called ProcOrder 62. ProcOrder parses the elements of the inbound e-mail messages in accordance with the original set up and instructions of the outbound e-mail messages 64. ProcOrder determines if all of the items that are required for an order to be completely processed automatically appear in the inbound e-mail message. For example, the script would look for the ordering token, such as the word “yes” or a series of letters depending on whether it is a single or multiple offer. The script would also look for footer information in the e-mail message, including a code that identifies the given campaign and the given offer, as seen in block 66 of FIG. 2B. In that example, there are four components in the footer, but only two are represented because the other two are not required in this instance. The first element is a customer identifier 68, e.g. 861270. Then there is a space 70 between two pipes that would contain the list identifier if there were one. There may be multiple recipient lists for a given marketing campaign. In the example, there is only one list, and there is no list identifier. A list number 243 might refer to a list of people who made a purchase at the ‘vendor’s web site or who subscribed at the web-site for a listserv.

The third footer item could be a source of awareness code 72, e.g., 3275, which identifies a particular marketing campaign. For example, in the case of FIG. 2, the code could refer to a Benchmarking Three-part Video Series offer.

The last item in the footer, located between the final pipe and the first right bracket would be a flight identification code 74. A given campaign could have multiple flights of e-mail messages.

After looking for the footer information, the ProcOrder parser looks for fields in the billing and shipping address blocks that are required to complete the order. What is required may vary with the type of campaign but typically the minimum requirements are a name and a physical address. If the information is not completely available in the response e-mail message, the script checks to see if it is available in the database 76. If not available in either place, the script generates an exception entry for an exception list. The exception list is provided to a service representative 46 who can then act on it (without involving the vendor's customer service organization), e.g., by sending back an e-mail message asking for the shipping address.

If all required information is available, the script generates a fully fielded valid order in a format required by the fulfillment system of the vendor and adds it to a batch of valid orders 78 which are sent electronically to the fulfillment process.

Confirmation E-Mail Message

As a result of running the ProcOrder script, an e-mail message 80 is returned to each customer either to confirm an order or to request more information. In the latter case, a dialog ensues and is managed by software and through an exception handling service as explained earlier. For example, the customer's response could say something like “sure, send”; or “send it and I'll take a look.” Shortly thereafter the customer would receive a confirmation “Thank you for your order; you can expect the CD-ROM in about seven business days. Please let us know if there is anything else we can do to help simply by replying to this e-mail.”

One-Click Ordering

Another feature of the e-mail dialog with a customer involves simplifying and optimizing the presentation of content. In the examples of FIGS. 1 and 2, the information is presented in a simple text format. It is useful also to provide in-line HTML code in the outbound e-mail message in a manner similar to the one-click ordering that Amazon.com offers in a web-site context. In one-click ordering, the customer sets up an account by providing credit card and shipping information. On subsequent visits to the web site, the customer can pick a product with one click, place an order, and have it shipped. A similar technique could be adapted to e-mail message interchange by embedding one-click ordering into e-mail.

An advantage of in-line HTML code is the opportunity for a much higher response rate because of the higher graphical contact and higher level of engagement normally achieved by a graphical message.

Template

The outbound e-mail messages are set up in a standard format using templates 90. The templates enable either a single-offer message or a multiple-offer message. Other templates are also possible, including one that embeds in-line HTML into the message as mentioned above, either for the single-offer or multiple-offer cases.

In addition, a set-up tool 92 permits the parameters of a given campaign to be defined, including the source of awareness code, the flight identification code, the campaign identification code, and similar information. The set-up tool also permits defining the tokens that are to be used in a given campaign (for example, the letters assigned to different products being offered). The set-up tool also allows a definition of the required fields that must appear in a given campaign to enable automated generation of orders to an existing fulfillment system.

The set-up tool also provides a user interface that enables a vendor to help in entering the set-up information.

The result of applying the tool to the templates is a set of outbound message forms 94 that are ready for use.

Reporting Tool

After the template is set up and the system is ready to launch a flight, address 108 and other information 110. 112 stored in the target list of customers is merged with the message forms, and the e-mail messages are automatically generated and sent by an outbound e-mail delivery engine 96. Customers then begin to respond. The ProcOrder script generates automatic orders to the fulfillment system and exception information for additional processing.

A reporting tool 104 aggregates-information about the responses for a given campaign according to source of awareness code and flight. The information is made available on-line to the vendor and can be used for a variety of marketing purposes. The information could be generated as an Excel file attached to an e-mail, or as a paper-based report, or as an electronic file that is transferred on a batch basis.

Gathering Additional Information from Database

There may be an intermediate step between the parsing engine's (ProcOrder) extraction of information from an e-mail message and the generation of the valid order. The intermediate step could be a querying process 112 to gather additional information from an existing database. The additional information may not have been included in the outbound e-mail messages but may be needed to generate a valid order. For example, product codes 112 may be stored in the database but not included in the outbound e-mail message. The letters entered by the customer can be mapped to the actual product codes by reference to the tables of the database based upon the source of awareness code.

The resulting valid order is a fully-fielded record that has the fields required by the client's order fulfillment system to process an order.

Exception Treatment

Exception handling can be treated in different ways depending on the circumstances. For example, an exception might occur when a customer responds from an e-mail client that does not quote the original text of the outbound e-mail message. The inbound e-mail message then has the customer's e-mail address, a subject line that says “Iyes”, and the original subject line from the campaign, but does not have the required information for the shipping address or the footer information. ProcOrder would kick that out as an exception, but the exception handling system-would allow a response management representative 46, based on the e-mail address, to confirm, from the database 76, that all of the required information is available. Use of the subject line allows the system to tie back to the appropriate campaign and to figure out who is ordering and what he is ordering. A valid order can be created without further interaction with the customer other than to send him a confirmation that the system has been able to enter a valid order on his behalf.

The system thus recognizes that it is not likely to be possible to automate every interaction with the customer, but it may be possible to complete a dialog with essentially all of the customers from whom inbound e-mail messages are received by automatically identifying messages that will require custom human handling and providing information and tools that enable the human handlers to complete the exception transactions in an efficient manner.

Non-Order Response Processing

Not every inbound e-mail message is an order. Non-order messages include undeliverable bounced messages to ad hoc customer service responses. Non-order inbound e-mail messages must be identified by the parsing engine.

Undeliverable e-mail messages 114 are automatically separated from the inbound e-mail stream and stored for offline handling by a human response handling professional, who operates a script on the files of undeliverable messages. The script classifies them as “soft” and “hard,” parses e-mail addresses and footer data from the messages, matches the parsed records to the database, and flags appropriate records as “undeliverable”.

Other non-order messages also are handled manually as explained earlier.

Vendor Creation of E-Mail Campaigns.

A campaign creation tool 126 is provided to a vendor to enable simple entry of all information needed to create an e-mail campaign, including all the parameters, the text of the messages, and the tables of data needed in the database. The vendor delivers the campaign electronically to the transactional e-mail processor which then delivers the e-mail messages, receive the responses, processes all exceptions, and returns to the fulfillment system the vendor orders in a proper format.

A web-based vendor interface 128 enables on-line viewing by the vendor of the status of all campaigns, including the state of those that are in development and the results of those that are “live”. The information is hosted by the transactional e-mail processor in part based on the database 76. The interface also gives the vendor a mechanism to check text and other content into the database.

Alternatively, instead of automatically permitting the vendor to fully create a finished campaign, the vendor may be enabled to download and check into the database a proposed campaign. Then an account executive of the e-mail handler process would review it and work with the vendor to complete it before it is finally queued for distribution.

Appendices A, B, and C contain more detailed descriptions of aspects of implementations of the invention. Appendix D contains source code written of an example of the ProcOrder process.

Other implementations are within the scope of the following claims.

What is claimed is:

1. A machine-based method comprising
analyzing an e-mail message to derive response information concerning a commercial transaction, and based on the derived information, and
automatically generating commercial transaction data in a format that is usable to automatically complete the commercial transaction.

2. The method of claim 1 in which the commercial transaction comprises an order for a product or service.

3. The method of claim 1 in which the e-mail message comprises at least part of an e-mail sent to a customer and responses of the customer to the e-mail.

4. The method of claim 1 in which the automatic completion of the commercial transaction comprises order fulfillment.

5. A machine-based method comprising
sending an e-mail message to a customer offering a product or service for sale, the e-mail message comprising locations for response by the customer indicating his intention to order the product or service,
receiving from the customer an e-mail message that includes the response,
based on the received e-mail, automatically generating order information in a format usable automatically by an order fulfillment system to cause the order to be filled.

6. A machine-based method comprising
analyzing an e-mail message to derive response information concerning a commercial transaction,
automatically identifying response information which requires resolution of an issue with the source of the e-mail message, and
automatically managing an e-mail dialog with the source to resolve the issue.

7. The method of claim 6 in which at least some of the e-mail dialog is performed automatically.

8. Software guided interactive e-mail dialogs to resolve, on behalf of a vendor, customer issues that occur in direct response e-mails that are automatically identified as requiring a dialog.

9. A machine-based method comprising
automatically sorting e-mail messages, based on response information contained in the messages, into e-mail messages that can be processed automatically to generate commercial transactions, e-mail messages in which the response information is inadequate to permit generation of commercial transactions, and e-mail messages that may be subjected to exception handling to yield information that is sufficient to generate commercial transactions.

10. A machine-based method comprising
analyzing an e-mail message to derive response information concerning a commercial transaction, and
automatically generating a confirmatory e-mail message to the source of the e-mail message confirming that the commercial transaction has been or will be completed.

11. A machine-based method comprising
receiving inbound e-mail messages that result from corresponding outbound e-mail messages associated with a marketing program, the inbound messages containing response information, each of the outbound messages being associated with a distinct piece of the marketing program, and
automatically associating the response information in each of the inbound messages with the corresponding distinct piece of the marketing program.

12. The method of claim 11 in which the piece comprises a marketing campaign or a marketing flight.

13. The method of claim 11 in which the inbound messages contain information that links them to the corresponding outbound messages, and the associating step uses the link information.

14. The method of claim 13 further comprising automatically parsing the inbound messages for order information.

15. A machine-based method comprising
sending outbound e-mail messages associated with commercial transactions,
storing information related to each of the outbound messages in a database, the information being useful for completing the commercial transactions, the information not being contained in the outbound messages,
analyzing inbound e-mail messages that result from the outbound messages and that contain response information useful in completing the commercial transactions, and
automatically merging the response information with corresponding information in the database for use in completing the transactions.

16. A machine-based method comprising
sending outbound e-mail messages associated with commercial transactions,
storing information related to each of the outbound messages in a database, the information being useful for completing the commercial transactions, the information not being contained in the outbound messages,
analyzing inbound e-mail messages that result from the outbound messages and that contain response information useful in completing the commercial transactions,
identifying inbound e-mail messages that cannot be processed automatically to generate the commercial transactions, and
using the database information to assist in exception handling of the identified inbound messages.
